(19) United States
(12) Patent Application Publication
(10) Pub. No.: US 2026/0039474 A1
(43) Pub. Date: Feb. 5, 2026

(54) FAST SYNC BLOCKCHAIN SYSTEM AND METHOD

(71) Applicant: Visa International Service Association, San Francisco, CA (US)

(72) Inventors: Adithya Bhat, San Mateo, CA (US); Mohammad Mohsen Minaei Bidgoli, San Jose, CA (US); Mahdi Zamani, Mercer Island, WA (US)

(73) Assignee: Visa International Service Association, San Francisco, CA (US)

(21) Appl. No.: 18/997,428

(22) PCT Filed: Jul. 25, 2023
(86) PCT No.: PCT/US2023/070968

§ 371 Date: Jan. 21, 2025

Related U.S. Application Data
(60) Provisional application No. 63/392,079, filed on Jul. 25, 2022.

(51) Int. Cl. H04L 9/32; H04L 9/00

(52) U.S. Cl. CPC H04L 9/3236; H04L 9/50

(57) ABSTRACT

An embodiment includes a node receiving one or more blocks of a blockchain. The node comprising a data storage can store, in the data storage, a plurality of sets of keys and data values associated with keys of the plurality of sets of keys, the data values being data associated with the blockchain. The node can perform a validation process for the one or more blocks. The validation process includes for each of the one or more blocks a) identifying a set of keys associated with the block, b) retrieving data values associated the identified keys from the data storage, c) storing the retrieved data values into volatile memory, and d) validating the block using the data values in the volatile memory. The node can then complete the validation of the one or more blocks.

### CROSS-REFERENCES TO RELATED APPLICATIONS

This application claims the benefit of U.S. Provisional Application No. 63/392,079, filed Jul. 25, 2022, which is herein incorporated by reference in its entirety for all purposes.

### BACKGROUND

Cache algorithms can utilize a cache of information stored on a computer. An LRU (Least Recently Used) cache mechanism is widely used as a caching mechanism to load data from a NoSQL database.

Current blockchains, such as Ethereum, utilize the LRU cache mechanism. For example, when a first block of transactions for a blockchain is verified by a node, the node needs to first load information regarding the first block. The node can then load the block information using key-value pairs and usage counts of the key-value pairs in the LRU cache.

This LRU caching mechanism assumes that the future data access is unknown. LRU caching mechanisms manage data in RAM by removing the oldest data value in the RAM. LRU caching mechanisms work well when mining new blocks for the blockchain since the next data that is to be loaded is unknown. However, such caching mechanisms are inefficient when verifying existing block data. This is because, the next data that is to be loaded for verification is known since the block already exists.

Embodiments of the disclosure address this problem and other problems individually and collectively.

### SUMMARY

One embodiment includes a method comprising: receiving, by a node, one or more blocks of a blockchain; storing in a data storage, by the node, a plurality of sets of keys and data values associated with keys of the plurality of sets of keys, the data values being data associated with the blockchain; performing, by the node, a validation process for the one or more blocks, wherein the validation process includes for each of the one or more blocks: identifying, by the node, a set of keys associated with the block; retrieving, by the node, data values associated the identified keys from the data storage; storing, by the node, the retrieved data values in a volatile memory; and validating, by the node, the block using the data values in the volatile memory; and completing, by the node, the validation of the one or more blocks.

Another embodiment is related to a node comprising: a processor; and a computer-readable medium coupled to the processor, the computer-readable medium comprising code executable by the processor for implementing a method comprising: storing, in a data storage, sets of keys and data values associated with keys of the sets of keys, the data values being data from blocks in a blockchain; performing a validation process for the blockchain, wherein the validation process includes for one or more blocks in the blockchain: identifying a set of keys associated with the block; retrieving data values associated the identified keys from the data storage; storing the retrieved data values in a volatile memory; and validating the block using the data values in the volatile memory; and completing the validation of the blockchain.

Another embodiment is related to a method comprising: receiving, by a provider computer, a blockchain data request message from a node; generating, by the provider computer, a blockchain data response message comprising a plurality of hint headers comprising sets of keys; and providing, by the provider computer, the blockchain data response message to the node, wherein the node uses the sets of keys in the plurality of hint headers to validate a blockchain.

Further details regarding embodiments of the disclosure can be found in the Detailed Description and the Figures.

### BRIEF DESCRIPTION OF THE DRAWINGS

FIG. 1 shows a block diagram of a blockchain caching system according to embodiments.

FIG. 2 shows a block diagram of components of a node according to embodiments.

FIG. 3 shows a block diagram of components of a provider computer according to embodiments.

FIG. 4 shows a block diagram illustrating block hints according to embodiments.

FIG. 5 shows a block diagram illustrating a caching method according to embodiments.

FIG. 6 shows a flowchart illustrating a caching method according to embodiments.

FIG. 7 shows a diagram illustrating a data structure according to embodiments.

FIG. 8 shows a diagram illustrating parts of a block from a blockchain according to embodiments.

### DETAILED DESCRIPTION

Prior to discussing embodiments of the disclosure, some terms can be described in further detail.

An “interaction” may include a reciprocal action or influence. An interaction can include a communication, contact, or exchange between parties, devices, and/or entities. Example interactions include a transaction between two parties and a data exchange between two devices. In other embodiments, an interaction can include a payment transaction in which two devices can interact to facilitate a payment.

“Interaction data” can include data related to and/or recorded during an interaction. In some embodiments, interaction data can be transaction data of the network data. Transaction data can comprise a plurality of data elements with data values.

An “amount” can include a quantity of something. An amount can include a total of a thing or things in number, size, value, or extent.

A “digital asset” may refer to digital content associated with a value. In some cases, the digital assets may also indicate a transfer of value. For example, a digital asset may include data indicating a transfer of monetary value (e.g., legal or cryptocurrency). In other embodiments, the digital assets may correspond to other non-monetary values, such as access rights data (e.g., number of authorized uses or time allocation for accessing information) and ownership data (e.g., digital rights data).

An “asset transfer network” may be a network for providing and/or receiving digital assets. The asset transfer network may include a plurality of nodes. In some embodiments, digital assets transmitted in an asset transfer network may be recorded in a ledger of transactions. An example of an asset transfer network may be a blockchain network, where the ledger for a transaction may take the form of a blockchain. In some embodiments, the asset transfer network may be a computer network.

The term “node” may include a connection point. In some embodiments, a node may be a physical electronic device that is capable of creating, receiving, or transmitting data. In other embodiments, the node may be a software module on a computing device that is a connection point in a communication network. In some embodiments, the node may be a computing device within an asset transfer network. The node can cast an asset, transfer an asset, receive an asset, validate an asset, maintain a ledger for a transaction, and/or perform any other suitable function. In some embodiments, the node may be associated with and/or operated by a financial institution computer (e.g., a bank), a payment processor computer, a third party computer, a user, or any other suitable entity.

The term “ledger” may include a compilation of data. The ledger may be a database or other comparable file structure that may be configured to store data from all previous digital asset transfers, including the date and time of the transfer, the transfer amount, and the identity information of the transfer participants (e.g., the sender and receiver of the transfer amount). In some embodiments, the ledger can be in the form of an electronic ledger (e.g., a blockchain), where data already stored in the electronic ledger can be unalterable. Portions (i.e., shards) of the ledger may be stored at the node. A ledger can be an interaction ledger.

The ledger can include transaction records that are digitally signed (e.g., with a private key) to protect entries in the ledger from being tampered with by spurious data. This prevents duplicate costs and makes transfers unchangeable and irreversible, thus making the ledger trustworthy.

A “blockchain” can include a secure data structure. A blockchain can include a series of blocks. Each block in the blockchain may include an electronic record of one or more historical transactions as well as metadata. In some embodiments, blocks in a blockchain may be related by including a reference to a previous block (e.g., a hash output of the previous block). Each new block in the blockchain may be algorithmically determined based on the new transaction and the previous blocks in the blockchain. As a result, any tampering of the data stored in these previous blocks can be detected. In some embodiments, the blockchain may be fragmented into blockchain fragments that are stored at a committee. For example, a committee may store a slice of a blockchain, while a different committee may store a different slice of the blockchain.

A “key value pair” can include a data representation in a computing system. Key-value pairs can be used by a data storage system for retrieving and managing associative arrays of data. Key value pairs can include two related data elements: a key and a value. A key value pair can be a general form of an array that charts the relationship between a key as an index and its values.

A “key” can include an identifier. A key can be a unique value that can identify another value. More specifically, a key can include an address of the value in a data structure. A key can be a constant that defines a data set, while a value can be a variable that belongs to the set. For example, the data set include a blockchain data structure. A key can be a constant value such as an identifier that identifies a location in the blockchain data structure.

A “value” can include data. In some embodiments, a value can include data from a block in a blockchain. A value can be identified by a unique key. While a key can be a constant that defines a data set, a value can be a variable that belongs to the set. For example, the data set include a blockchain data structure. A value can be a value that is included in the blockchain data structure as is identified by a key. A value can be a timestamp, a hash value, a name, an entity identifier, a nonce, a difficulty value, interaction data, and/or any other data that can be included in a blockchain data structure.

A “hint” can include an indication of something. A hint can include an indication of what values can be used in a verification process. In some embodiments, a hint can be a key that references a value in a blockchain data structure.

A “hint header” can be a data object that contains hints. A hint header can include a set of hints. A hint header can include a block identifier that identifies a block in a blockchain that corresponds to the hint header. In some embodiments, a node can retrieve a set of hints from a hint header.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Embodiments of the disclosure allow for efficient methods to utilize keys (e.g., hints) to load data objects in random access memory (RAM) during validation of a blockchain's block(s). Embodiments allow for provider computers (e.g., miner computers, blockchain snapshot provider computers, etc.) to generate hint headers for a block by generating a set of keys necessary to process the block. During a synchronization process with the blockchain, new nodes can use the hint headers comprising sets of keys to efficiently verify the blockchain while reducing time for the disk data load.

Cache algorithms can be optimizing instructions, or algorithms that can utilize a cache of information stored on the computer. A LRU (Least Recently Used) cache mechanism is widely used as a caching mechanism to load data from a NoSQL database.

Blockchains, such as Ethereum, utilize the LRU cache mechanism to verify block data. For example, when a first block of a blockchain is verified by a node, the node needs to first load information regarding the first block. The node can load the following key value pairs as well as their usage counts in the LRU cache, as depicted in Table 1.

TABLE 1
First LRU cache illustration.

| Key | Value | Usage |
|---|---|---|
| 0xa1f | 0xaaf1 . . . | 1 |
| 0x09f | 0xff10 . . . | 1 |
| 0x998 | 0xdaf1 . . . | 1 |

After verifying the first block, the node can retrieve data for the second block. The node can load the following key value pairs as depicted in Table 2. The values of “0xaaf1 . . . ” and “0xff10 . . . ” have each been used again, so the usage value increases to two.

TABLE 2
Second LRU cache illustration.

| Key | Value | Usage |
|---|---|---|
| 0xa1f | 0xaaf1 . . . | 2 |
| 0x09f | 0xff10 . . . | 2 |
| 0x998 | 0xdaf1 . . . | 1 |

After verifying the second block, the node can retrieve data for a third block. The node can determine that the key 0xdf1a is needed to verify the third block. The node can search for the key 0xdf1a in the LRU cache. Since the key of 0xdf1a is not included in the cache depicted in Table 2, the node can find and delete (e.g., remove from the LRU cache) the least recently used entry. The node can then load the key and value for the key of 0xdf1a from a disk into the LRU cache. To load the data from disk, the node needs to identify where the relevant data is stored and needs to search the dataset for the data, which can add delays to the validation process.

Embodiments of the invention can improve the speed of blockchain verification processes. Blockchains can store data such as data for payment transactions, data events, and other type of information. Nodes in a distributed network may be asked to verify that a blockchain is valid and accurate, and/or that certain data (e.g., a payment transaction) as recorded on a valid blockchain. Once the blockchain is verified, other tasks may be performed. For example, once a blockchain has been validated and a past transaction is confirmed as being on the valid blockchain, a refund or other type of process could be initiated.

Embodiments provide for more efficient caching systems and methods than the LRU caching mechanisms used by current blockchain networks. Current blockchain protocols use LRU caching mechanisms that assume that the future data that is to be accessed is unknown. LRU mechanisms manage data in RAM by removing the oldest data value in the RAM. However, in some applications such as blockchain synchronization, all the data needed for verifying a block is known beforehand. Embodiments can utilize per-block hints to have objects ready in RAM for processing. For example, provider computers (e.g., block miners, snapshot provider computers, etc.) can generate hints by generating a set of keys (e.g., data object references) needed to process a block.

The hints can be keys which may be addresses or indicators of objects in the data set that stores blockchain data (e.g., header data, block data, transaction data, etc.). For example, the key of 0xaa can be an address in the dataset that points to where the associated value (e.g., data object) is located in the dataset. The associated object can be, for example, a date/time, a transaction amount, a transaction party, a digital signature, etc. For example, a key value pair can include a key of “0xaa” and a value of “1/1/2023 11:30 AM.”

In some embodiments, the hints can be stored in a data container (e.g., a hint header) outside of the block. In other embodiments, the hints can be stored in the block itself. Hint generation and utilization are described in further detail below.

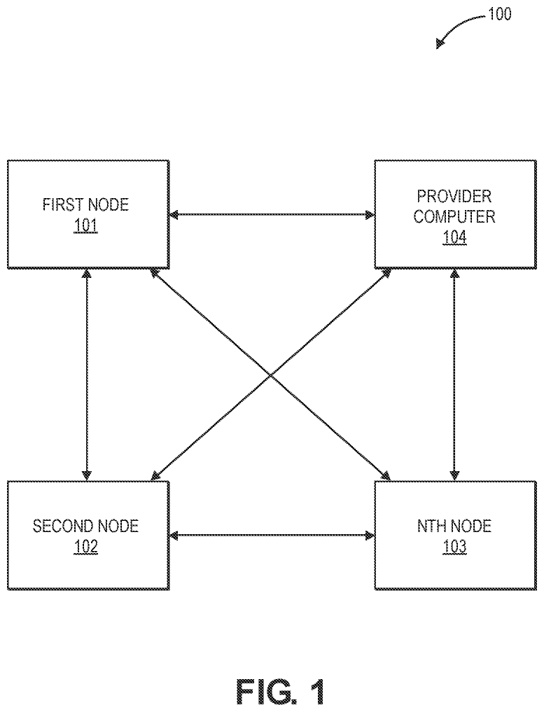

FIG. 1 shows a system 100 according to embodiments of the disclosure. The system 100 can be a distributed computer network, and can be characterized as a blockchain network in some embodiments. The system 100 can comprise a first node 101, a second node 102, an Nth node 103, and a provider computer 104.

The first node 101 can be in operative communication with the second node 102, the Nth node 103, and the provider computer 104. The second node 102 can be in operative communication with the first node 101, the Nth node 103, and the provider computer 104. The Nth node 103 can be in operative communication with the first node 101, the second node 102, and the provider computer 104. The provider computer 104 can be in operative communication with the first node 101, the second node 102, and the Nth node 103.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. For example, there can be any number of nodes in the system 100.

Messages between the devices in the system 100 in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

A node, such as the first node 101, the second node 102, and the Nth node 103, can be a node in a blockchain network. A node can perform interactions and have the interactions be added to the blockchain. A node can store a blockchain and blockchain data for the blockchain, which can include data of each previous block in the blockchain. A node can validate one or more blocks. A node can also create new blocks for a blockchain.

The provider computer 104 can include a computer in the blockchain network that creates hints. In some embodiments, the provider computer 104 can be a miner computer that creates new blocks for the blockchain. The provider computer 104 can be a snapshot provider computer that provides the current blockchain to other computers upon request. The provider computer 104 can be a full node.

The provider computer 104 can generate sets of hints for each block that is added to the blockchain. The set of hints can include one or more hints. A hint can be a key in a value key pair data structure. As such, the provider computer 104 can generate sets of keys that include one or more keys. The provider computer 104 can provide a plurality of sets of keys upon request. The provider computer 104 can generate the set of keys based on which values associated with the keys are needed to validate a particular block.

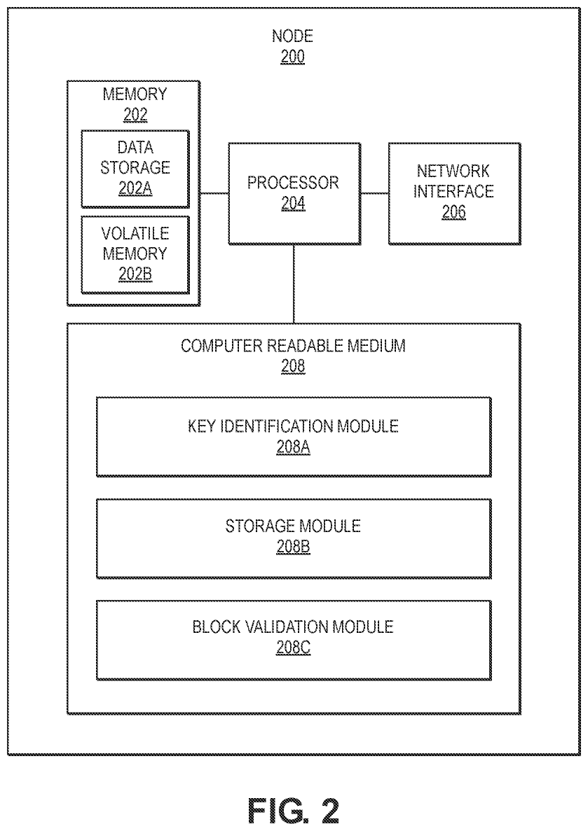

FIG. 2 shows a block diagram of a node 200 according to embodiments. The exemplary node 200 may comprise a processor 204. The processor 204 may be coupled to a memory 202, a network interface 206, and a computer readable medium 208. The computer readable medium 208 can comprise one or more software modules. For example, the computer readable medium 208 can comprise a key identification module 208A, a storage module 208B, and a block validation module 208C.

The memory 202 can be used to store data and code. For example, the memory 202 can store block data. The memory can include a data storage 202A and a volatile memory 202B. The data storage 202A can be a non-volatile or semi-volatile memory. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: storing, in a data storage, sets of keys and data values associated with keys of the sets of keys, the data values being data from blocks in a blockchain; performing a validation process for the blockchain, wherein the validation process includes for one or more blocks in the blockchain: identifying a set of keys associated with the block; retrieving data values associated the identified keys from the data storage; storing the retrieved data values into a volatile memory; and validating the block using the data values in the volatile memory; and completing the validation of the blockchain.

The key identification module 208A may comprise code or software, executable by the processor 204, for identifying keys. The key identification module 208A, in conjunction with the processor 204, can receive a plurality of sets of keys. The plurality of sets of keys can be stored in the data storage 202A. Each set of keys can be included in a hint header of a plurality of hint headers. The hint header can include a block identifier, where the block identifier identifies to which block the hint header corresponds. The key identification module 208A, in conjunction with the processor 204, can identify a set of keys of the plurality of sets of keys that is associated with a current block being evaluated by the node 200. The key identification module 208A, in conjunction with the processor 204, can identify the hint header of the plurality of hint headers that includes a block identifier that corresponds to the current block. For example, the block identifier can identify block number 5. If the current block is block number 5, then the key identification module 208A, in conjunction with the processor 204, can identify the set of keys included in the hint header with the block identifier of 5.

The storage module 208B can include may comprise code or software, executable by the processor 204, for maintaining and utilizing memory. The storage module 208B, in conjunction with the processor 204, can retrieve data from and store data in the data storage 202A and the volatile memory 202B. The storage module 208B, in conjunction with the processor 204, can receive a key that identifies a value in a blockchain data structure that is stored in the data storage 202A. The storage module 208B, in conjunction with the processor 204, can identify the value in the data storage 202A using the key and then retrieve the value from the data storage 202A. The storage module 208B, in conjunction with the processor 204, can then store the value into the volatile memory 202B for use by the block validation module 208C.

The block validation module 208C can include may comprise code or software, executable by the processor 204, for validating blocks. The block validation module 208C, in conjunction with the processor 204, can validate blocks of a blockchain. The block validation module 208C, in conjunction with the processor 204, can validate a block in any suitable manner using blockchain data. For example, the block validation module 208C, in conjunction with the processor 204, can validate a block by validating a proof-of-work for the block. As another example, the block validation module 208C, in conjunction with the processor 204, can verify that a hash of the block and its data (e.g., determined by hashing the block data) is equal to a given output value with a x number of leading zeros or other requirement. As another example, the block validation module 208C, in conjunction with the processor 204, can verify that the hash of the previous block is equal to the stored previous block hash value.

The network interface 206 may include an interface that can allow the node 200 to communicate with external computers. The network interface 206 may enable the node 200 to communicate data to and from another device (e.g., other nodes, the provider computer 104, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

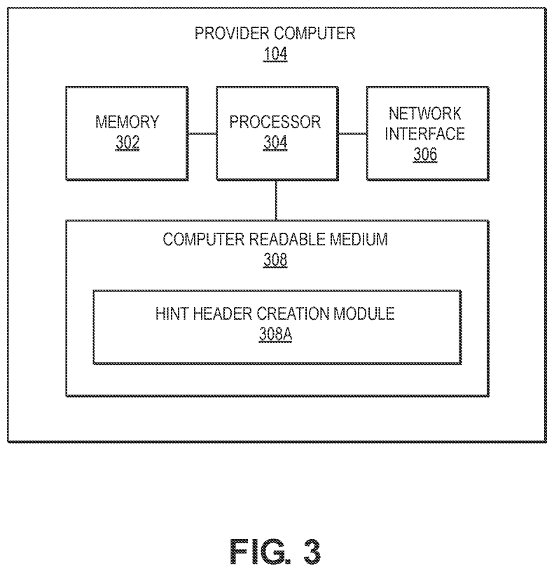

FIG. 3 shows a block diagram of the provider computer 104 according to embodiments. The exemplary provider computer 104 may comprise a processor 304. The processor 304 may be coupled to a memory 302, a network interface 306, and a computer readable medium 308. The computer readable medium 308 can comprise one or more modules. For example, the computer readable medium 308 can comprise a hint header creation module 308A.

The memory 302 can be used to store data and code. For example, the memory 302 can store block data. The memory 302 may be coupled to the processor 304 internally or externally (e.g., cloud based data storage), and may comprise any combination of volatile and/or non-volatile memory, such as RAM, DRAM, ROM, flash, or any other suitable memory device.

The computer readable medium 308 may comprise code, executable by the processor 304, for performing a method comprising: receiving, by a provider computer, a blockchain data request message from a node; generating, by the provider computer, a blockchain data response message comprising a plurality of hint headers comprising sets of keys; and providing, by the provider computer, the blockchain data response message to the node, wherein the node uses the sets of keys in the plurality of hint headers to validate a blockchain.

The hint header creation module 308A can include may comprise code or software, executable by the processor 304, for creating hint headers. A hint header can include a set of keys that correspond to values that can be utilized to validate the block corresponding to the hint header. The hint header creation module 308A, in conjunction with the processor 304. As values are utilized during block creation, or during block validation, the hint header creation module 308A, in conjunction with the processor 304, can store a set of keys associated with the utilized values. The keys can be addresses that identify the values in the blockchain data structure. The hint header creation module 308A, in conjunction with the processor 304, can generate a hint header for the block. The hint header can include the set of keys and optionally the set of values associated with the keys.

The network interface 306 can be similar to the network interface 206 and will not be repeated here.

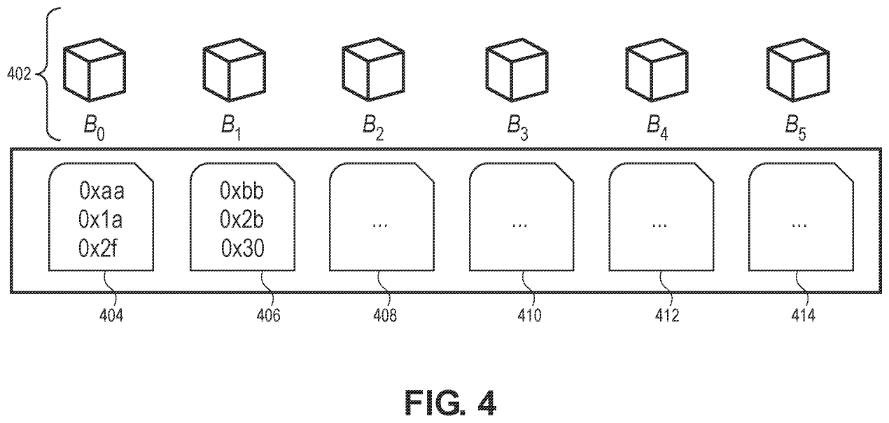

FIG. 4 shows a block diagram illustrating block hints. Each block in the blockchain 402 can be associated with a set of hints. Each set of hints can include one or more hints. Each hint can be an address of a data object needed to process the associated block.

A first block B0 is associated with a first set of hints 404. The first set of hints 404 includes three hints of 0xaa, 0x1a, and 0x2f. A node, when processing the first block B0, can utilize these three hints to preemptively load the data objects referenced by the hints from a data storage (e.g., a disk) into volatile memory (e.g., RAM). Then, when processing the first block B0, the node can quickly access the relevant data objects (e.g., transactions, dates, times, etc.) stored in the block from the volatile memory.

A second block B1 is associated with a second set of hints 406, which include 0xbb, 0x2b, and 0x30. A third block B2 is associated with a third set of hints 408, a fourth block B3 is associated with a fourth set of hints 410, a fifth block B4 is associated with a fifth set of hints 412, a sixth block B5 is associated with a sixth set of hints 414, and so on for each block of the blockchain.

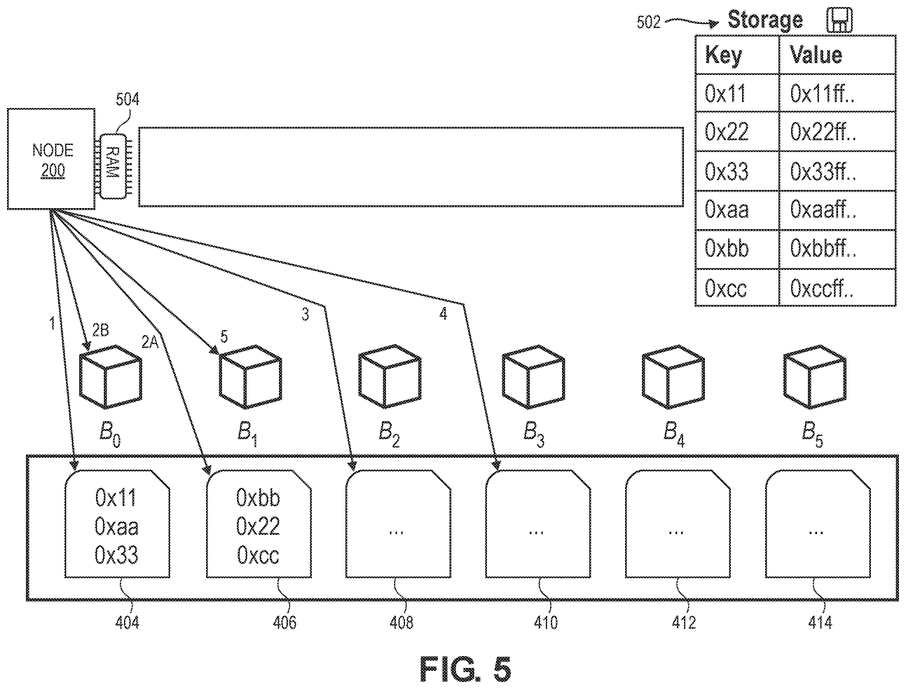

FIG. 5 shows a block diagram illustrating a caching method according to embodiments. The method illustrated in FIG. 5 will be described in the context of a node 200 verifying blocks in a blockchain network. The node 200 can include a data storage 502 and a volatile storage 504 (e.g., RAM).

Prior to step 1, the node 200 can obtain data in a data storage 502 (e.g., a non-volatile data storage such as a disk) from one or more nodes in the blockchain network. The data storage 502 can include blockchain data that represents a current state of the blockchain. The node 200 can attempt to verify the blocks in the received data that is stored in the data storage 502. For example, the node 200 can verify a block by validating a proof-of-work for the block. For example, the node 200 can verify that a hash of the block and its data is equal to a given output value with a x number of leading zeros or other requirement. As another example, the node 200 can verify that the hash of the previous block is equal to the stored previous block hash value.

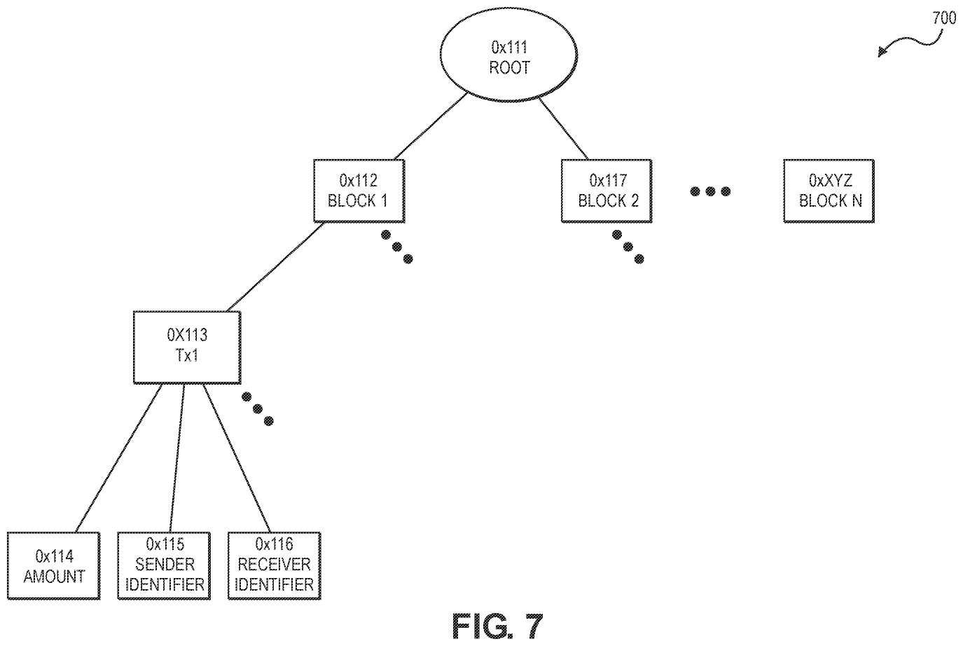

At step 1, the node 200 can evaluate the first set of hints 404 for the first block B0. The node 200 can access the data values in the data storage 502 as indicated by the hints. For example, each hint in the first set of hints 404 can be a key that indicates an address in the block data structure (as further described in reference to FIG. 7). The first set of hints 404 includes the keys (e.g., data addresses) of 0x11, 0xaa, and 0x33. The node 200 can identify the keys in the data storage 502 and access the values stored in association with the keys in the data storage 502. The node 200 can load the values that are associated with the keys into the volatile memory 504.

For example, the node 200 can identify the key of “0x11” in the data storage 502 and retrieve the value of “0x11ff . . . ” that is stored in association with the key. Further, the node 200 can identify the key of “0xaa” in the data storage 502 and retrieve the value of “0xaaff . . . ” that is stored in association with the key. The node 200 can identify the key of “0x33” in the data storage 502 and retrieve the value of “0x33ff . . . ” that is stored in association with the key. The node 200 can load the values of “0x11ff . . . ,” “0xaaff . . . ,” and “0x33ff . . . ” into the volatile memory 504 from the data storage 502. The loading of the values into the volatile memory can be referred to as caching the values.

As an illustrative example, the key of 0x11 (e.g., data structure address) can be associated with a value of a first transaction amount of $5, the key of 0xaa can be associated with a sender identifier of the first transaction of “Jane123,” and the key of 0x33 can be associated with a value of a receiver identifier of the first transaction of “John123.”

After evaluating the first set of hints 404 and loading the relevant values into the volatile memory 504, the node 200 can proceed to steps 2A and 2B. Steps 2A and 2B may occur simultaneously or in any order. During step 2A, the node 200 can begin loading the second set of hints 406 into RAM. During step 2B, the node 200 can begin validating the first block B0 with the data loaded in RAM during step 1. The validation of the blocks can be asynchronously performed from the loading of data into RAM. As such, after loading the data values into the volatile memory 504 as indicated by the first set of keys for the first block B0, the node 200 can load data values indicated by the second set of keys for a second block B1 while validating the data in the first block B0 using the values in the volatile memory 504.

For example, at step 2A, the node 200 can evaluate the second set of hints 406 for the second block B1. The node 200 can access the data values in the data storage 502 as indicated by the hints. The second set of hints 406 includes the keys (e.g., data addresses) of 0xbb, 0x22, and 0xcc. The node 200 can identify the keys in the data storage 502 and access the values stored in association with the keys in the data storage 502. The node 200 can load the values that are associated with the keys into the volatile memory 504.

For example, the node 200 can identify the key of “0xbb” in the data storage 502 and retrieve the value of “0xbbff . . . ” that is stored in association with the key. Further, the node 200 can identify the key of “0x22” in the data storage 502 and retrieve the value of “0x22ff . . . ” that is stored in association with the key. The node 200 can identify the key of “0xcc” in the data storage 502 and retrieve the value of “0xccff . . . ” that is stored in association with the key. The node 200 can load the values of “0xbbff . . . ,” “0x22ff . . . ,” and “0xccff . . . ” into the volatile memory 504 from the data storage 502.

For example, at step 2B, the node 200 can validate the first block B0 using values loaded into the volatile memory 504. The node 200 can validate blocks of a blockchain using any suitable verification process using the values loaded into the volatile memory 504. For example, the node 200 can verify that a hash of the block and its data is equal to a given output value with a x number of leading zeros. The values loaded into the volatile memory 504 can include data that can be utilized to perform the verification. For example, the values loaded into the volatile memory 504 can include block data of the first block B0 (e.g., a root hash, a previous hash, a nonce, a timestamp, a difficulty value, etc.). The node 200 can compute the hash of the block using the block data. The node 200 can compare the computed block hash value with the difficulty value to verify whether or not the block was created correctly with respect to the difficulty value.

The node 200 can validate any portion of the block using the values loaded in the volatile memory 504. If the node 200 needs to utilize a value that was not loaded into the volatile memory 504, then the node 200 can load the needed value from the data storage 502. Such a case may occur if the set of hints did not include all needed keys or was otherwise incorrectly created. In the worst case scenario, if the set of hints is created completely wrong, then the node 200 can load the needed values from the data storage 502, which is approximately computationally equivalent to current LRU caching mechanisms minus a constant loading time longer (e.g., from loading the values indicated by the hints). A malicious entity could not generate wrong hints that negatively affect the system other than causing a minor constant length of time delay as the node 200 needs to load the correct values from the data storage 503.

After step 2A where the node 200 loads values for the second block B1 into the volatile memory 504, the node 200 can continue to load values based on hints until the volatile memory 504 is full or there are no more values to load. For example, at step 3, the node 200 can begin loading the values indicated by the hints of the third set of hints 408 into the volatile memory 504. At step 4, the node 200 can being loading values indicated by the hints of the fourth set of hints 410 into volatile memory 504.

At step 5, after the first block B0 has been validated, the node 200 can begin validating the second block B1 using the preloaded values in the volatile memory 504, which were loaded during step 2A. The second block B1 can be validated in any suitable manner using the values in the volatile memory 504. The second block B1 can be validated in a similar manner to the first block B0.

The node 200 can continue preemptively loading data values into the volatile memory 504 (e.g., RAM) and validating blocks until each block is validated (and the blockchain is validated) or the node 200 otherwise determines that the process should stop (e.g., finds an incorrect node).

The node 200 can also remove data values from the volatile memory 504 on a periodic basis or upon the occurrence of certain events. In some embodiments, the node 200 can remove data values from the volatile memory 504 once the volatile memory 504 has been filled with data. The node 200 can remove the oldest values stored in the volatile memory 504 before the newest values in the volatile memory 504. For example, the node 200 can remove values in the volatile memory 504 based on a first in first out (FIFO) removal process. The point at which the node 200 fills the volatile memory 504 with values (e.g., used up all of the available empty space in RAM) can depend on the memory capacity of the volatile memory 504. Therefore, the node 200 can remove values at different times during the method illustrated in FIG. 5 depending on the volatile memory 504 available to the node 200.

In other embodiments, the node 200 can remove values from the volatile memory 504 after a block, with which the values are associated, has been validated. For example, a first set of values as identified by a first hint header for a first block of a blockchain can be stored in the volatile memory 504. Once the node 200 has validated the first block in the blockchain, the node 200 can remove (e.g., delete) the first set of values from the volatile memory 504. The node 200 can remove sets of values corresponding to blocks after the corresponding block has been validated. In some embodiments, the node 200 can remove a set of values corresponding to a block after a predetermined (e.g., 2, 3, 5, 10, etc.) number of blocks have been validated. As such, the node 200 removes values after they have been in the volatile memory 504 during a predetermined number of block validations.

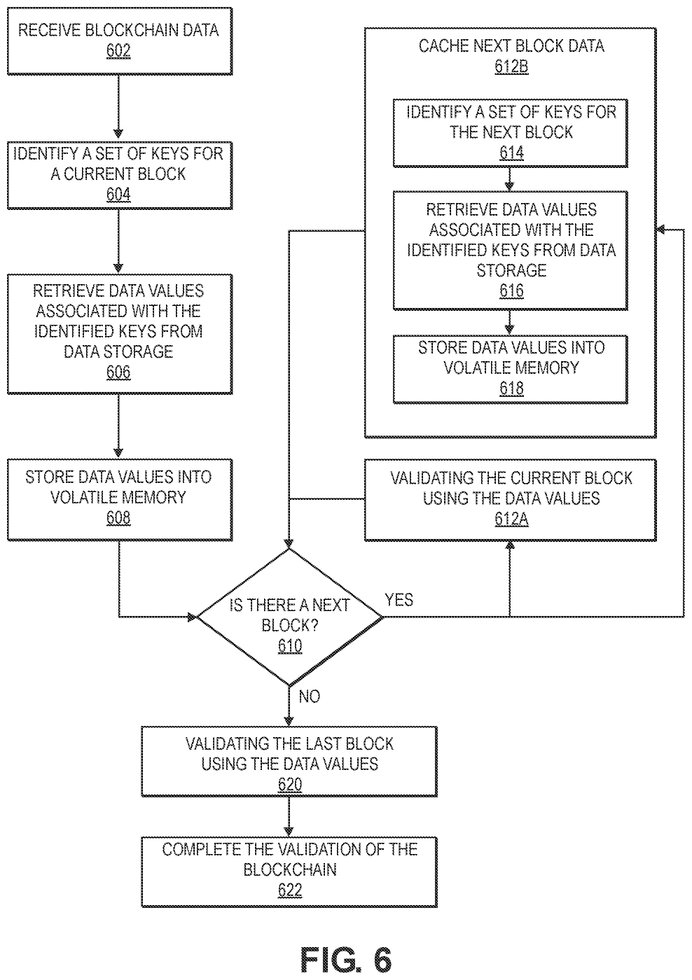

FIG. 6 shows a flowchart of a caching method according to embodiments. The method illustrated in FIG. 6 will be described in the context of the node 200 requesting blockchain data from the provider computer 104. The node 200 can proceed to analyze the received blockchain data to verify that the received blockchain data is correct and valid.

Prior to step 602, the node 200 can generate a blockchain data request message. The blockchain data request message can include a request for blockchain data of the current blockchain. The blockchain data request message can include a request for one or more blocks of the blockchain. The node 200 can send the blockchain data request message to the provider computer 104 or can broadcast the blockchain data request message to the blockchain network.

The provider computer 104 can receive the blockchain data request message from the node 200. The provider computer 104 can generate a blockchain data response message comprising the blockchain data. In some embodiments, the blockchain data can include data for each block in the blockchain. In other embodiments, the blockchain data can include data for one or more blocks. The provider computer 104 can also include a plurality of sets of keys (e.g., a plurality of sets of hints). Each set of keys can include keys that correspond to values in the blockchain data. Each set of keys can correspond to a different block of the blockchain. Each set of keys of the plurality of sets of keys can be included in a hint header that is associated with (e.g., by a block identifier) a block of the blockchain.

After generating the blockchain data response message, the provider computer 104 can provide the blockchain data response message to the node 200.

At step 602, the node 200 can receive the blockchain data response message comprising the blockchain data. For example, the node 200 can receive one or more blocks of the blockchain, which are associated with key value pairs that indicate data (values) and where the data is located in the blockchain data structure. The node 200 can also receive the plurality of sets of keys, where each set of keys is included in a hint header.

The node 200 can store the received data into a data storage of the node 200. The data storage can be a non-volatile memory (e.g., a computer disk). In some embodiments, the data storage can be a semi-volatile memory. For example, the node 200 can store the sets of keys and the data values associated with the sets of keys in the data storage.

After receiving the blockchain data, the node 200 can begin the validate the blockchain data.

At step 604, the node 200 can identity a set of keys of the plurality of sets of keys that correspond to a current block. The current block can be an initial block that the node 200 validates. The current block can be the first block in the blockchain. The set of keys that correspond to the first block can be the first set of keys in the plurality of sets of keys.

As an example, the node 200 can identify a hint header associated with the block using a block identifier. For example, the first block can have a block identifier of 1. The corresponding hint header can include a block identifier of 1. The hint header includes the set of keys associated with validation of the block.

At step 606, after identifying the set of keys, the node 200 can retrieve data values associated with the keys of the set of keys from the data storage. Each key can be an address that identifies a value (e.g., a data value) in the received blockchain data structure.

As an illustrative example, the set of keys can include a keys of the following key value pairs “K1”—“previousHash,” “K2”—“nonce,” “K3”—“rootHash,” “K8—“hash0,” “K9”—“difficultyValue,” “K12”—“interaction1Amount,” “K13”—“interaction1Sender,” “K14”—“interaction1Receiver.”

At step 608, after retrieving the data values associated with the keys of the set of keys from the data storage, the node 200 can store the data values into volatile memory (e.g., RAM). For example, the previousHash, the nonce, the rootHash, the hash0, the difficultyValue, the interaciton1Amount, the interaction1 Sender, and the interaction1Receiver values can be stored into the volatile memory.

At step 610, after storing the data values into the volatile memory, the node 200 can determine whether or not there is a next block in the blockchain to validate. If there is a next block in the blockchain, then the node 200 can proceed to steps 612A and 612B, which can be performed asynchronously. If there is not a next block 610, then the node 200 can proceed to step 620.

Steps 612A and 612B can be performed concurrently with one another. However, it is understood that in some embodiments, the node 200 can cache one or more next block data into volatile memory prior to the current block being validated. As such, step 612B for future blocks can be performed prior to step 612A for the current block (e.g., as described in reference to FIG. 5).

At step 612A, the node 200 can validate the current block using the data values stored in the volatile memory. The node 200 can validate any data of the current block.

For example, the node 200 can validate hash0. Hash0 can be a hash of the data of the interaction 1 that is included in the block. The node 200 can hash the data related to interaction 1, including the interaction1Amount, the interaction1Sender, and the interaction1Receiver, to form a determined hash value. The node 200 can compare the determined hash value to hash0. If the determined hash value and hash0 match, then the node 200 can determined that hash0 in the block is valid.

As another example, the node 200 can validate that the block was created during a valid proof-of-work process. For example, the node 200 can generate a hash the previousHash, the nonce, and the rootHash together to obtain a determined hash value. The node 200 can compare the determined hash value to the difficultyValue. If the determined hash value satisfies the difficultyValue, then the block is valid. For example, the block can be considered to be valid if the determined hash value is lower than the difficultyValue.

At step 612B, the node 200 can begin to cache the next block data into the volatile memory. Step 612B can include steps 614, 616, and 618.

At step 614, the node 200 can identify a next set of keys of the plurality of sets of keys that correspond to the next block. For example, the next block can be the second block of the blockchain. The node 200 can identify that the second set of keys of the plurality of sets of keys correspond to the second block. Step 614 can be similar to step 604.

After identifying the set of keys, at step 616, the node 200 can retrieve the next data values associated with the keys of the next set of keys from the data storage. Step 616 can be similar to step 606.

At step 618, the node 200 can store the data values into volatile memory (e.g., RAM). Step 618 can be similar to step 608. For example, the node 200 can stored the retrieved next data values into the volatile memory.

In some embodiments, the node 200 can remove previous values that were used to validate the previous block from the volatile memory. In other embodiments, the node 200 can begin to remove values in the volatile memory once the volatile memory is full. Values removed from the volatile memory can be removed based on a first in first out data removal process.

After the node 200 has asynchronously performed steps 612A and 612B, the node 200 can proceed to step 610 to determine if there is a next block to validate.

At step 620, if there is no next block to validate, the node 200 can validate the current block (e.g., the last block) using the data values stored into the volatile memory. Step 620 can be similar to step 612A.

At step 622, the node 200 can complete the validation of the blockchain after each block that needed to be validated was validated.

After validating the blockchain, the node 200 can perform additional processing. For example, the node 200 can initiate an interaction with another node, begin mining a new block, etc. For example, after completing the validation, the node can submit a new interaction that is to be included in the blockchain. The new interaction can include interaction details such as an amount, a receiver address, and a sender address. The blockchain network can perform a validation and consensus process to determine whether or not to include the new interaction in a new block.

FIG. 7 shows a block diagram illustrating a data structure according to embodiments. The data structure 700 illustrated in FIG. 7 can be a structure of the data loaded in the data storage 502 illustrated in FIG. 5. The data structure 700 is an illustrative data structure and it is understood that the data structure utilized by embodiments may differ from the data structure 700.

Each data object (e.g., entry in the data structure 700) can have a key that identifies the data object. The data structure 700 includes a root with a key of 0x111. The root data object can include the block data objects of block 1 and block 2. The root data object can include any suitable number of blocks.

Each block object can include interaction data objects. For example, the block 1 data object includes the interaction 1 data object. Further, each interaction data object can include details regarding the interaction. For example, the interaction 1 data object includes an amount, a sender identifier, and a receiver identifier.

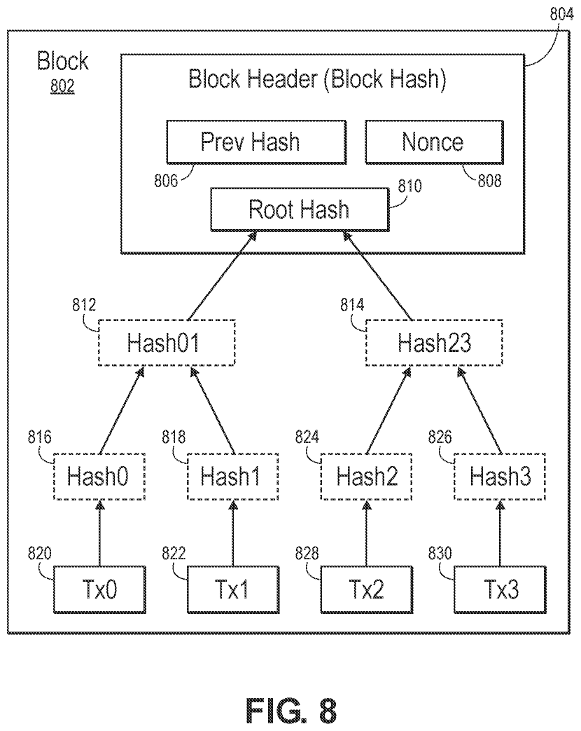

FIG. 8 shows a block diagram illustrating a block 802 from a blockchain according to embodiments. The block 802 can include a block header 804 (which in some embodiments, can be hashed as a block hash).

The block header 804 includes a previous hash (e.g., a hash value of the previous block in the blockchain), a nonce 808, and a root hash 810.

The root hash 810 can be a hash value that is determined from the interaction that are included in the block 802. The root hash 810 can be determined based on a first combine hash value Hash01 812 and a second combine hash value Hash23 814. Each combine hash value can be created from two hash values.

The first combine hash value Hash01 812 can be created by hashing together a first hash value Hash0 816 and a second hash value Hash1 818. Each hash value is created by hashing data from an interaction that is included in the block 802. The first hash value Hash0 816 is created by hashing first interaction data Tx0 820. The second hash value Hash1 818 is created by hashing second interaction data Tx1 822.

The second combine hash value Hash23 814 can be created by hashing together a third hash value Hash2 824 and a fourth hash value Hash3 826. The third hash value Hash2 824 is created by hashing third interaction data Tx2 828. The fourth hash value Hash3 826 is created by hashing fourth interaction data Tx3 830.

An example protocol which is aligned with the process of FIG. 6 is illustrated in Table 3, below.

TABLE 3
FastSync Algorithm.

| | |
|---|---|
| Init(cache size): −> pool | Sync(tx size, pool size) |
| While cache size not full: | txs = Init(tx size) |
| (sync) load keys into pool | pool = Init(pool size) |
| | While True: |
| Update(pool): −> pool | Select: |
| While cache size not full: | Execution finished: |
| (async) load keys into pool | cleanup pool, txs |
| | execute transactions in txs |
| | nPool = Update(pool) −> ready: |
| | pool = nPool |
| | nPool = Update(pool) |
| | nTxs = Update(txs) −> ready: |
| | txs = nTxs |
| | nTxs = Update(txs) |

Embodiments can be utilized for memories between L1 cache and L2 cache, L2 cache and L3 cache, L3 cache and RAM, RAM and Optane memory, Optane and Disk memory, and/or Disk and RAID. Furthermore, embodiments can be utilized to cache transactions, contract logic, contract state, block headers, etc.

Embodiments of the disclosure have several advantages. For example, new nodes, irrespective of their RAM capacities, can take advantage of the hints. Since the data needed to verify a block is pulled into RAM before validation of the block starts, the delay of pulling such data from a non-volatile memory such as a disk is avoided. This can be significant then there are many blocks and many data values associated with those blocks. In some cases, the pipeline will never stall, and block synchronization and validation will only be compute bound.

Further, the sets of hints do not impact the security of the system. For example, even if the sets of hints are wrong or maliciously generated, the node that is using the hints to validate the blocks will determine that the data preemptively loaded in RAM is the wrong data and will instead determine that the hints are wrong and retrieve the appropriate data from the data set.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a node, one or more blocks of a blockchain;
storing in a data storage, by the node, a plurality of sets of keys and data values associated with keys of the plurality of sets of keys, the data values being data associated with the blockchain;
performing, by the node, a validation process for the one or more blocks, wherein the validation process includes for each of the one or more blocks:
identifying, by the node, a set of keys associated with the block;
retrieving, by the node, data values associated the identified keys from the data storage;
storing, by the node, the retrieved data values in a volatile memory; and
validating, by the node, the block using the data values in the volatile memory; and
completing, by the node, the validation of the one or more blocks.

2. The method of claim 1, wherein the data storage is a non-volatile memory or semi-volatile memory.

3. The method of claim 2, wherein the non-volatile memory is a computer disk.

4. The method of claim 1, wherein the volatile memory is random access memory.

5. The method of claim 1, wherein the one or more blocks includes the keys and the data values associated with the blockchain, wherein the method further comprises:
receiving, by the node, the plurality of sets of keys from a provider computer.

6. The method of claim 1, wherein identifying the set of keys associated with the block further comprises:
evaluating, by the node, a hint header associated with the block, wherein the hint header includes the set of keys associated with validation of the block.

7. The method of claim 6 further comprising:
receiving, by the node, a plurality of hint headers from a provider computer; and
storing, by the node, the plurality of hint headers in the data storage.

8. The method of claim 1, wherein the data values in the volatile memory include a previous hash value, a nonce, and a root hash, and wherein validating the block further comprises:
hashing, by the block, the data in the block to obtain a determined hash value; and
validating, by the node, whether or not the determined hash value matches a hash value that is included in a next block.

9. The method of claim 1, wherein the keys include addresses that identify locations of corresponding data values in a blockchain data structure.

10. The method of claim 1, wherein the block is a current block and wherein while validating the current block using the data values in the volatile memory:
identifying, by the node, a next set of keys associated with a next block;
retrieving, by the node, next data values associated the identified next keys from the data storage; and
storing, by the node, the retrieved next data values into the volatile memory.

11. The method of claim 10 further comprising:
after retrieving the next data values, removing, by the node, the retrieved data values from the volatile memory.

12. The method of claim 10 further comprising:
removing, by the node, the retrieved data values from the volatile memory the volatile memory is full, wherein older data values in the volatile memory are removed before newer data values.

13. A node comprising:
a processor; and
a computer-readable medium coupled to the processor, the computer-readable medium comprising code executable by the processor for implementing a method comprising:
storing, in a data storage, sets of keys and data values associated with keys of the sets of keys, the data values being data from blocks in a blockchain;
performing a validation process for the blockchain, wherein the validation process includes for one or more blocks in the blockchain:
identifying a set of keys associated with the block;
retrieving data values associated the identified keys from the data storage;
storing the retrieved data values in a volatile memory; and
validating the block using the data values in the volatile memory; and
completing the validation of the blockchain.

14. The node of claim 13, wherein the data storage is a non-volatile or semi-volatile memory, and wherein the volatile memory is random access memory.

15. The node of claim 13, wherein the method further comprises:
receiving a plurality of hint headers from a provider computer; and
storing the plurality of hint headers in the data storage, wherein identifying the set of keys associated with the block further comprises:
evaluating a hint header associated with the block, wherein the hint header includes the set of keys associated with validation of the block.

16. The node of claim 13, wherein the keys include addresses that identify locations of corresponding data values in a blockchain data structure.

17. The node of claim 13, wherein the block is a current block and wherein while validating the current block using the data values in the volatile memory:
identifying a next set of keys associated with a next block;
retrieving next data values associated the identified next keys from the data storage; and
storing the retrieved next data values into volatile memory.

18. A method comprising:
receiving, by a provider computer, a blockchain data request message from a node;
generating, by the provider computer, a blockchain data response message comprising a plurality of hint headers comprising sets of keys; and
providing, by the provider computer, the blockchain data response message to the node, wherein the node uses the sets of keys in the plurality of hint headers to validate a blockchain.

19. The method of claim 18, wherein each hint header includes a block identifier that identifies a block in the blockchain.

20. The method of claim 18, wherein the node:
stores, in a data storage, the sets of keys;
performs a validation process for the blockchain, wherein the validation process includes for one or more blocks in the blockchain:
identifies a set of keys associated with a hint header of the plurality of hint headers for the block;
retrieves data values associated the identified keys from the data storage;
stores the retrieved data values into volatile memory; and
validates the block using the data values in the volatile memory; and
completes the validation of the blockchain.
